(19) United States
(12) Patent Application Publication
(10) Pub. No.: US 2005/0287249 A1
(43) Pub. Date: Dec. 29, 2005

(54) Prepared sandwich type foods comprising dietary fiber gel

(76) Inventors: Triveni P. Shukla, Mukwonago, WI (US); Gregory J. Halpern, Vernon Hills, IL (US)

Correspondence Address: Fullin Legal Services LLC, 711 N. Milwaukee Avenue, Libertyville, IL, 60048, US

(21) Appl. No.: 10/878,900

(22) Filed: Jun. 28, 2004

(51) Int. Cl. A23G 3/00

(52) U.S. Cl. 426/94

(57) ABSTRACT

A prepared sandwich type food including a filling between or on edible layers and having reduced fat and caloric content is described. The filling and the edible layers can comprise dietary fiber gel which replaces fat that is normally found in the ingredients and recipes for the filling and the edible layers. The use of dietary fiber gel permits manipulation of the fat and caloric content of prepared sandwich type foods with minimal effect on taste and texture. Furthermore, the prepared sandwich type food can further comprise functional foods that increase health and nutritional benefits of the prepared sandwich type food. The functional foods can be added individually, and in any combination thereof. Hence, in addition to reducing fat and caloric content of prepared sandwich type food by replacing a portion of fat with dietary fiber gel, additional health benefits can be achieved with compositions that include functional foods.

### STATEMENT REGARDING FEDERALLY SPONSORED RESEARCH/DEVELOPMENT

The present invention does not involve any form of federally sponsored research or development.

### CROSS-REFERENCE TO RELATED APPLICATIONS

Not Applicable

### BACKGROUND OF THE INVENTION

The present invention relates to prepared foods, including, but not limited to, prepared sandwich type foods that contains dietary fiber gel. Recent media attention to the global problem of obesity demonstrates a need for greater availability of foods with low caloric and fat content. This is especially true for foods that typically have high fat and caloric content, such as prepared sandwich type foods.

Prepared sandwich type foods are, generally, preformed foods that can be conveniently reheated in an oven, microwave, or other heating medium. Typically, the prepared sandwich type foods include a filling on or between edible layers. The filling can be varied and can depend on the type of sandwich. Some types of prepared sandwiches have filling that includes meats, cheeses including processed cheeses, dressings, sauces, spreads, and so forth. Other types of prepared sandwich type food have filling that includes pie fillings, fruit fillings, and so forth. Filling typically contains fat. Other ingredients in the filling can vary according to the type of filling and the recipe followed, but many fillings are high in both fat and caloric content.

The edible layers of prepared sandwich type foods are separate, distinct, and non-connected layers with filling in between. In addition, the layers can be connected so as to form a pouch that is filled with filling. Edible layers can be a single layer that is folded around a filling such as a wrap, a pancake, a crepe, taco, and so forth. In addition, prepared sandwich type foods can include a single edible layer with filling on top such as an open-faced sandwich. The edible layers can include crust, pastry, bread, bread dough derived materials, and so forth. The edible layers typically comprise some fat. Other ingredients of the edible layers can vary according to the type of edible layer and the recipe, but typically, edible layers are high in both fat and caloric content. The term “edible layer”, as used in this document, is intended to include rolls and pancakes, and pancake mixes.

In recent years, companies have begun to offer prepared sandwich type foods having reduced fat content. This variety of prepared sandwich type foods, however, often fails to retain the desirable taste and texture of prepared sandwich type foods comprising higher fat contents.

Accordingly, there is a need for a reduced fat and caloric content prepared sandwich type food that has the desirably flavor and texture of high fat and high caloric content prepared sandwich type food.

### BRIEF SUMMARY OF THE INVENTION

A composition of matter for use in producing high-fiber, low-calorie and low-fat prepared sandwich type foods is provided. The composition includes dietary fiber gel that partially replaces fat in the edible layers and filling of a prepared sandwich type food. In addition, provided compositions can include other functional ingredients so as to produce prepared sandwich type foods that are nutritionally fortified.

### DETAILED DESCRIPTION OF THE PREFERRED EMBODIMENT

The description that follows discloses the use of dietary fiber gel in prepared sandwich type foods that include a filling on or between edible layers. The composition of the filling and the edible layers can include dietary fiber gel. When substituted for fat containing compounds, dietary fiber gels reduce the fat and calorie content of food products. Dietary fiber gels are fully described in U.S. Pat. No. 5,766,662 (the '662 patent). These dietary fiber gels comprise insoluble dietary fibers consisting of morphologically disintegrated cellular structures, and are characterized by their ability to retain large amounts of water. Dietary fiber gel can be a gellable product or a gel powder depending on water content. Typically, dietary fiber gel is produced as a gellable product that is dried to remove water so as to produce a gel powder having a reduced water content. Dietary fiber gels are characterized by high hydration capacity when reconstituted with water. Additionally, these dietary fiber gels are characterized by their high viscosity at low solid levels. Other insoluble fibers derived from cereals, grains and legumes derived by conventional dry milling consist of morphologically in tact cellular structures, and thus impart a gritty texture to the foods in which they are contained. The dietary fiber gels disclosed in the '662 patent, however, consist of morphologically disintegrated cellular structures and thus impart a smoother texture than other insoluble fiber formulations.

The filling and the edible layer of prepared sandwich type foods can include dietary fiber gel so as to reduce fat and caloric content of the prepared sandwich type food. The dietary fiber replaces fat containing compounds normally found in the filling and the edible layers. This replacement of fat does not adversely affect either the taste or texture of the prepared sandwich type foods. The result is that fat and caloric content of prepared sandwich type foods can be manipulated with minimal effect on taste and texture.

The filling of prepared sandwich type foods can include meats, cheeses including processed cheeses, dressings, sauces, spreads, and so forth. The meat in the filling can include processed meats, such as all types of sausages including hot dogs and fish dogs, ground meats, pressed meats, and the like, vegetable-derived meat substitutes, vegetable burgers, and so forth. Processed meats can be formulated such that the processed meat comprises 0.1 percent to 8.0 percent dietary fiber gel solids by replacing an appropriate amount, that is, an amount prorated to deliver this range of dietary fiber gel solids, of fat, including oil and liquid shortening. Vegetable-derived meat substitutes such as vegetable burgers can be formulated such that the processed meat comprises 0.1 percent to 8.0 percent dietary fiber gel solids by replacing an appropriate amount, that is, an amount prorated to deliver this range of dietary fiber gel solids, of fat, including oil and liquid shortening.

The filling can include cheese including processed cheeses. Processed cheeses can be formulated such that the processed cheese comprises 0.1 percent to 4.0 percent dietary fiber gel solids by replacing an appropriate amount, that is, an amount prorated to deliver this range of dietary fiber gel solids, of fat, including oil and liquid shortening. The added dietary fiber gel solids increases the moisture content of the processed cheese while simultaneously lowering the fat content.

The filling can include dressings such as creamy-type dressings, vinaigrette-type dressings, and mayonnaise. Alternatively, the dressings can be provided in the form of a dressing mix with the intention that a consumer can mix and reconstitute the dressing at a convenient, post-purchase time, and dressing mixes are considered to be within the scope of this invention. As such, for purposes of this document, the term “dressings” is defined to include dressing mixes.

Vinaigrette dressings, for example Italian, oil and vinegar, and the like, can be formulated such that the dressing comprises 0.1 percent to 0.8 percent dietary fiber gel solids by replacing an appropriate amount, that is, prorated to deliver this range of dietary fiber gel solids, of fat, including oil and liquid shortening. Creamy dressings, for example ranch, blue cheese, creamy Italian, and the like, as well as mayonnaise, can be formulated such that the dressing comprises 0.1 percent to 4.0 percent dietary fiber gel solids by replacing an appropriate amount, that is, prorated to deliver this range of dietary fiber gel solids, of fat, including oil and liquid shortening.

The filling can include sauces. Sauces can be of a number of different varieties, including but not limited to cheese sauces, creamy type sauces, alfredo sauces, and gravies. Alternatively, the sauces can be provided in the form of sauce mixes with the intention that a consumer can mix them at a convenient, post-purchase time, and sauce mixes are considered to be within the scope of this invention. As such, for purposes of this document, the term “sauces” is defined to include sauce mixes.

The sauces can be formulated such that the sauces comprise 0.5 percent to 8.0 percent dietary fiber gel solids by replacing an appropriate amount, that is, prorated to deliver this range of dietary fiber gel solids, of fat, including oil and liquid shortening.

The filling can include spreads. The spreads can be formulated such that up to 90 percent, preferably 50 percent, of the fat in a spread is replaced with dietary fiber gels.

The filling can include other ingredient including but not limited to pie fillings, fruit fillings, and so forth that can be formulated with dietary fiber gel that replaces and appropriate amount, that is, prorated to deliver a desired range of dietary fiber gel solids, of fat.

Alternatively, the filling can be provided in the form of filling mixes with the intention that a consumer can mix the filling at a convenient, post-purchase time, and filling mixes are considered to be within the scope of this invention. As such, for purposes of this document, the term “filling” is defined to include filling mixes.

Besides the filling, prepared sandwich type foods include edible layers that can be a crust, pastry, bread, bread dough derived materials, and so forth. The edible layers can be separate, distinct, and non-connected layers with filling in between or on the layers. In addition, the layers can be connected so as to form a pouch that is filled with filling. Alternatively, edible layers can be provided in the form of mixes with the intention that a consumer can mix and bake them at a convenient, post-purchase time, and mixes are considered to be within the scope of this invention. Similarly, edible layers can also be provided in the form of dough with the intention that a consumer can bake them at a convenient, post-purchase time, and the dough is considered to be within the scope of this invention. As such, for purposes of this document, the term “edible layers” includes mixes and dough.

Different categories of edible layer are available to consumers, including conventional breads and pancakes. For example, conventional breads, such as Italian, French, wheat, multigrain, oat, rye, pumpernickel, white, and the like, can be formulated such that the bread comprises 0.2 percent to 5.0 percent dietary fiber gel solids by replacing an appropriate amount, that is, an amount prorated to deliver this range of dietary fiber gel solids, of fat, including oil and liquid shortening, with dietary fiber gel based substitutes. Pancakes, including for example buckwheat, buttermilk and the like, and pancake mixes, can be formulated such that the pancakes, and pancakes made from the pancake mixes, comprise 0.2 percent to 4.0 percent dietary fiber gel solids by replacing an appropriate amount, that is, an amount prorated to deliver this range of dietary fiber gel solids, of fat, including oil and liquid shortening, with dietary fiber gel based substitutes. The replacement of fat with dietary fiber gel does not adversely affect either the taste or texture of the edible layer. In fact, in the case of bread dough that can be used to form edible layers, but is formed to produce toast, croutons and bread chips, the fiber gel added according to the present invention results in lower breakage occurring in the final packaging by adding tensile strength to the food product.

The result is that fat and caloric content of prepared sandwich type food can be manipulated with minimal effect on taste and texture, and as stated above, additional health benefits can be achieved through consumption of prepared sandwich type food comprising dietary fiber gel when functional foods are included in the formulations.

Functional ingredients can be added to the composition of the edible layers and the filling in order to increase the health and nutritional benefits of sandwich type prepared foods. Most notably functional foods such as high omega three and omega six oils and pure omega three and omega six fatty acids, medium chain triglyceride, beta carotene, calcium stearate, vitamin E, bioflavonoids, fagopyritrol, polyphenolic antioxidants of vegetable origin, lycopene, luteine and soluble fiber, for example Beta-Glucan derived from yeast, and other soluble fibers derived from grain, flax seed, and other vegetable and fruit fiber sources can be added to the edible layers and the filling.

The following ranges of the functional foods in either the edible layer or the filling are given by way of example, but other functional foods, notably fat soluble functional foods, can be added as well. High omega three oils and omega six oils, for example flax seed oil, can be added in concentrations of 1 percent to 50 percent of the composition by weight. Pure omega three fatty acids and omega six fatty acids can be added in concentrations ranging from 1 percent to 30 percent of the composition by weight. If both pure omega three or six fatty acids and high omega six oils are used, their respective concentrations can be prorated to give an appropriate end concentration of high omega six fatty acids. Medium chain triglyceride can be added in concentrations ranging from 1 percent to 30 percent of the composition by weight. Fagopyritrol or foods containing fagopyritol can be added in concentrations of 0.25 percent to 20 percent of the composition by weight. Polyphenolic antioxidants of vegetable origin, for example lycopene, beta carotene, luteine, and bioflavonoids can be added alone or in combination in concentrations ranging from 0.25 percent to 20 percent of the composition by weight. Soluble fiber, for example beta Glucan, can be added in concentrations ranging from 5 percent to 15 percent of the composition by weight. Any functional foods added to the composition can be added in such concentrations to deliver up to 100 percent, preferably 25 percent to 100 percent, of prevailing recommended daily intake prescribed by the FDA, European Commission, FAO, Codex Alimentarius, or other international authorities.

An advantage of the present invention is the ability to provide a unique composition of matter embodied by low-calorie and low-fat prepared sandwich type food. The fat and caloric content are advantageously reduced by the replacement of the fat normally found in prepared sandwich type foods with compositions comprising dietary fiber gel. Food compositions that reduce caloric and fat content answer an unmet need in the food industry to provide the consuming public with a healthier, higher fiber alternative to traditional prepared sandwich type foods that typically are inherently fattening. Another advantage is the providing of prepared sandwich type foods that have been fortified with insoluble fiber and other functional foods. Yet another advantage is that the fat replacement with dietary fiber gel does not adversely affect either the taste or texture of the prepared sandwich type foods. Finally, the fat and caloric content of prepared sandwich type foods can be advantageously manipulated with minimal adverse effect on taste and texture, and additional health benefits can be achieved through composition of prepared sandwich type foods comprising dietary fiber gel when functional foods are included in the formulations.

Although the present invention is illustrated by the example of prepared sandwich type foods that include filling between edible layers, the present invention applies to foods and food formulations that include fat containing ingredients such as oils, greases, and lards that are derived from vegetable, animal, or synthetically produced that are used in the mixing, baking, reheating or other processing as necessary to produce edible foods. The present invention applies to prepared sandwich type foods that can be formed from a single edible layer, multiple edible layers, folded edible layers, wrapped edible layers, and so forth. The physical form of the prepared sandwich type food includes, but is not limited to sandwiches, wraps, pancakes, crepe, tacos, pies, and so forth. The prepared sandwich type food can be preformed or can come in a kit with ingredients to make the filling and/or the edible layers.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A prepared sandwich type food comprising:
a filling that comprises at least one ingredient that contains dietary fiber gel; and
at least one edible layer that contains dietary fiber gel.

2. The prepared sandwich type food of claim 1, wherein at least one edible layer is bread comprising dietary fiber gel, wherein the dietary fiber gel is added in a prorated amount such that solids contained within the dietary fiber gel fraction represent 0.2 percent to 5.0 percent by weight of the bread, and dietary fiber gel replaces an equal amount of fat used in an otherwise identical recipe of bread that uses no dietary fiber gel.

3. The prepared sandwich type food in claim 1, wherein at least one edible layer is a pancake comprising dietary fiber gel, wherein the dietary fiber gel is added in a prorated amount such that solids contained within the dietary fiber gel fraction represent 0.2 percent to 3.5 percent by weight of the pancake, and the dietary fiber gel replaces an equal amount of fat used in an otherwise identical recipe of pancakes that uses no dietary fiber gel.

4. The prepared sandwich type food in claim 1, wherein at least one edible layer is made from a bread mix comprising dietary fiber gel, wherein the dietary fiber gel is added in a prorated amount such that solids contained within the dietary fiber gel fraction represent 0.2 percent to 5.0 percent by weight of the bread mix as reconstituted bread mix, and the dietary fiber gel replaces an equal amount of fat used in an otherwise identical recipe of bread mix that uses dietary fiber gel.

5. The prepared sandwich type food in claim 1, wherein at least one edible layer is made from bread dough comprising dietary fiber gel, wherein the dietary fiber gel is added in a prorated amount such that solids contained within the dietary fiber gel fraction represent 0.2 percent to 5.0 percent by weight of the bread dough, and the dietary fiber gel replaces an equal amount of fat used in an otherwise identical recipe of bread dough that uses no dietary fiber gel.

6. The prepared sandwich type food in claim 1, wherein at least one edible layer is made from pancake mix comprising dietary fiber gel, wherein the dietary fiber gel is added in a prorated amount such that solids contained within the dietary fiber gel fraction represent 0.2 percent to 4.0 percent by weight of the pancake mix as reconstituted pancake mix, and the dietary fiber gel replaces an equal amount of fat used in an otherwise identical recipe of pancake mix that uses no dietary fiber gel.

7. The prepared sandwich type food in claim 1, wherein at least one ingredient of the filling is processed meat comprising dietary fiber gel, wherein the dietary fiber gel is added in a prorated amount such that solids contained within the dietary fiber gel fraction represent 0.1 percent to 8.0 percent by weight of the processed meat, and the dietary fiber gel replaces an equal amount of fat used in an otherwise identical recipe of processed meat that uses no dietary fiber gel.

8. The prepared sandwich type food in claim 1, wherein at least one ingredient of the filling is derived from hot dogs comprising dietary fiber gel, wherein the emulsified dietary fiber gel is added in a prorated amount such that solids contained within the dietary fiber gel fraction represent 0.1 percent to 8.0 percent by weight of hot dog, and the dietary fiber gel replaces an equal amount of fat used in an otherwise identical recipe for hot dogs that uses no dietary fiber gel.

9. The prepared sandwich type food in claim 1, wherein at least one ingredient of the filling is sausage comprising dietary fiber gel, wherein the dietary fiber gel is added in a prorated amount such that solids contained within the dietary fiber gel fraction represent 0.1 percent to 8.0 percent by weight of the sausage, and the dietary fiber gel replaces an equal amount of fat used in an otherwise identical recipe of sausage that uses no dietary fiber gel.

10. The prepared sandwich type food in claim 1, wherein at least one ingredient of the filling is pressed meat comprising dietary fiber gel, wherein the dietary fiber gel is added in a prorated amount such that solids contained within the dietary fiber gel fraction represent 0.1 percent to 8.0 percent by weight of the pressed meat, and the dietary fiber gel replaces an equal amount of fat used in an otherwise identical recipe of pressed meat that uses no dietary fiber gel.

11. The prepared sandwich type food in claim 1, wherein at least one ingredient of the filling is ground meat comprising dietary fiber gel, wherein the dietary fiber gel is added in a prorated amount such that solids contained within the dietary fiber gel fraction represent 0.1 percent to 8.0 percent by weight of the ground meat, and the dietary fiber gel replaces an equal amount of fat used in an otherwise identical recipe of ground meat that uses no dietary fiber gel.

12. The prepared sandwich type food in claim 1, wherein at least one ingredient of the filling is vegetable-derived meat substitute comprising dietary fiber gel, wherein the dietary fiber gel is added in a prorated amount such that solids contained within the dietary fiber gel fraction represent 0.1 percent to 8.0 percent by weight of the vegetable-derived meat substitute, and the dietary fiber gel replaces an equal amount of fat used in an otherwise identical recipe of vegetable-derived meat substitute that uses no dietary fiber gel.

13. The prepared sandwich type food in claim 1, wherein at least one ingredient of the filling is processed cheese comprising dietary fiber gel, wherein the dietary fiber gel is added in a prorated amount such that solids contained within the dietary fiber gel fraction represent 0.1 percent to 4.0 percent by weight of the processed cheese, and the dietary fiber gel replaces an equal amount of fat used in an otherwise identical recipe of processed cheese that uses no dietary fiber gel.

14. The prepared sandwich type food in claim 1, wherein at least one ingredient of the filling is a processed cheese spread comprising dietary fiber gel, wherein the dietary fiber gel is added in a prorated amount such that solids contained within the dietary fiber gel fraction represent 0.1 percent to 4.0 percent by weight of the processed cheese spread, and the dietary fiber gel replaces an equal amount of fat used in an otherwise identical recipe of processed cheese spread that uses no dietary fiber gel.

15. The prepared sandwich type food in claim 1, wherein at least one ingredient of the filling is vinaigrette dressing comprising dietary fiber gel, wherein the dietary fiber gel is added in a prorated amount such that solids contained within the dietary fiber gel fraction represent 0.1 percent to 0.8 percent by weight of the dressing, and the dietary fiber gel replaces an equal amount of fat used in an otherwise identical recipe of vinaigrette dressing that uses no dietary fiber gel.

16. The prepared sandwich type food in claim 1, wherein at least one ingredient of the filling is creamy dressing comprising dietary fiber gel, wherein the dietary fiber gel is added in a prorated amount such that solids contained within the dietary fiber gel fraction represent 0.1 percent to 4.0 percent by weight of the dressing, and the dietary fiber gel replaces an equal amount of fat used in an otherwise identical recipe of creamy dressing that uses no dietary fiber gel.

17. The prepared sandwich type food in claim 1, wherein at least one ingredient of the filling is mayonnaise comprising dietary fiber gel, wherein the dietary fiber gel is added in a prorated amount such that solids contained within the dietary fiber gel fraction represent 0.1 percent to 4.0 percent by weight of the mayonnaise, and the dietary fiber gel replaces an equal amount of fat used in an otherwise identical recipe of mayonnaise that uses no dietary fiber gel.

18. The prepared sandwich type food in claim 1, wherein at least one ingredient of the filling is a vinaigrette dressing mix comprising dietary fiber gel, wherein the dietary fiber gel is added in a prorated amount such that solids contained within the dietary fiber gel fraction represent 0.1 percent to 0.8 percent by weight of the dressing as reconstituted vinaigrette dressing mix, and the dietary fiber gel replaces an equal amount of fat used in an otherwise identical recipe of vinaigrette dressing mix that uses no dietary fiber gel.

19. The prepared sandwich type food in claim 1, wherein at least one ingredient of the filling is creamy dressing mix comprising dietary fiber gel, wherein the dietary fiber gel is added in a prorated amount such that solids contained within the dietary fiber gel fraction represent 0.1 percent to 4.0 percent by weight of the dressing as reconstituted creamy dressing mix, and the dietary fiber gel replaces an equal amount of fat used in an otherwise identical recipe of creamy dressing mix that uses no dietary fiber gel.

20. The prepared sandwich type food in claim 1, wherein at least one ingredient of the filling is sauce comprising dietary fiber gel, wherein the dietary fiber gel is added in a prorated amount such that solids delivered by the dietary fiber gel fraction represent 0.5 percent to 8.0 percent by weight of the sauce, and the dietary fiber gel replaces an equal amount of fat used in an otherwise identical recipe of sauce that uses no dietary fiber gel.

21. The prepared sandwich type food in claim 1, wherein at least one ingredient of the filling is sauce mix comprising dietary fiber gel, wherein the dietary fiber gel is added in a prorated amount such that solids contained within the dietary fiber gel fraction represent 0.5 percent to 8.0 percent by weight of the sauce as reconstituted, and the dietary fiber gel replaces an equal amount of fat used in an otherwise identical recipe of sauce mix that uses no dietary fiber gel.

22. The prepared sandwich type food in claim 1, wherein at least one ingredient of the filling is cheese sauce comprising dietary fiber gel, wherein the dietary fiber gel is added in a prorated amount such that solids delivered by the dietary fiber gel fraction represent 0.5 percent to 7.0 percent by weight of the cheese sauce, and the dietary fiber gel replaces an equal amount of fat used in an otherwise identical recipe of cheese sauce that uses no dietary fiber gel.

23. The prepared sandwich type food in claim 1, wherein at least one ingredient of the filling is creamy type sauce comprising dietary fiber gel, wherein the dietary fiber gel is added in a prorated amount such that solids delivered by the dietary fiber gel fraction represent 0.5 percent to 7.0 percent by weight of the creamy type sauce, and the dietary fiber gel replaces an equal amount of fat used in an otherwise identical recipe of creamy type sauce that uses no dietary fiber gel.

24. The prepared sandwich type food in claim 1, wherein at least one ingredient of the filling is alfredo sauce comprising dietary fiber gel, wherein the dietary fiber gel is added in a prorated amount such that solids delivered by the dietary fiber gel fraction represent 0.5 percent to 7.0 percent by weight of the alfredo sauce formulation, and the dietary fiber gel replaces an equal amount of fat used in an otherwise identical recipe of alfredo sauce that uses no dietary fiber gel.

25. The prepared sandwich type food in claim 1, wherein at least one ingredient of the filling is gravy comprising dietary fiber gel, wherein the dietary fiber gel is added in a prorated amount such that solids delivered by the dietary fiber gel fraction represent 0.5 percent to 8.0 percent by weight of the gravy, and the dietary fiber gel replaces an equal amount of fat used in an otherwise identical recipe of gravy that uses no dietary fiber gel.

26. The prepared sandwich type food in claim 1, wherein at least one ingredient of the filling is a spread comprising dietary fiber gel.

27. The prepared sandwich type food in claim 1, wherein at least one ingredient of the filling is a spread comprising fat and dietary fiber gel, wherein the dietary fiber gel fraction replaces up to 90 percent of fat used in an otherwise identical recipe of spread that uses no dietary fiber gel.

28. The prepared sandwich type food in claim 1, wherein the filling further comprises at least one functional food selected from a group consisting of
high omega three oil, wherein high omega three oil represents 1 percent to 50 percent of the filling by weight,
pure omega three fatty acid, wherein pure omega three fatty acid represents 1 percent to 30 percent of the filling by weight,
a combination of high omega three oil and pure omega three fatty acid, wherein the total omega three fatty acid present in the combination represents 1 percent to 30 percent of the filling by weight,
medium chain triglyceride, wherein medium chain triglyceride represents 1 percent to 30 percent of the filling by weight,
fagopyritrol, wherein fagopyritrol represents 0.25 percent to 20 percent of the filling by weight,
lycopene, wherein the lycopene represents 0.25 percent to 20 percent of the filling by weight, polyphenolic antioxidants of vegetable origin, wherein polyphenolic antioxidants represent 0.25 percent to 20 percent of the filling by weight,
luteine, wherein the luteine represents 0.25 percent to 20 percent of the filling by weight, beta carotene, wherein the beta carotene represents 0.25 percent to 20 percent of the filling by weight,
calcium stearate, wherein the calcium stearate represents 0.25 percent to 20 percent of the filling by weight,
vitamin E, wherein the vitamin E represents 0.25 percent to 20 percent of the filling by weight,
bioflavonoid, wherein the bioflavonoid represents 0.25 percent to 20 percent of the filling by weight,
a functional food having a daily intake reported by the United States Food and Drug Administration, wherein the filling contains 25 percent to 100 percent of prevailing daily intake recommendation by the United States Food and Drug Administration,
a functional food having a daily intake reported by the European Commission, wherein the filling contains 25 percent to 100 percent of prevailing daily intake recommendation by the European Commission,
a functional food having a daily intake reported by the FAO, wherein the filling contains 25 percent to 100 percent of prevailing daily intake recommendation by the FAO, and
a functional food having a daily intake reported by the Codex Alimentarius, wherein the filling contains 25 percent to 100 percent of prevailing daily intake recommendation by the Codex Alimentarius.

29. The prepared sandwich type food in claim 1, wherein the edible layer further comprises at least one functional food selected from a group consisting of
high omega three oil, wherein high omega three oil represents 1 percent to 50 percent of the filling by weight,
pure omega three fatty acid, wherein pure omega three fatty acid represents 1 percent to 30 percent of the filling by weight,
a combination of high omega three oil and pure omega three fatty acid, wherein the total omega three fatty acid present in the combination represents 1 percent to 30 percent of the filling by weight,
medium chain triglyceride, wherein medium chain triglyceride represents 1 percent to 30 percent of the filling by weight,
fagopyritrol, wherein fagopyritrol represents 0.25 percent to 20 percent of the filling by weight,
lycopene, wherein the lycopene represents 0.25 percent to 20 percent of the filling by weight,
polyphenolic antioxidants of vegetable origin, wherein polyphenolic antioxidants represent 0.25 percent to 20 percent of the filling by weight,
luteine, wherein the luteine represents 0.25 percent to 20 percent of the filling by weight,
beta carotene, wherein the beta carotene represents 0.25 percent to 20 percent of the filling by weight,
calcium stearate, wherein the calcium stearate represents 0.25 percent to 20 percent of the filling by weight,
vitamin E, wherein the vitamin E represents 0.25 percent to 20 percent of the filling by weight,
bioflavonoid, wherein the bioflavonoid represents 0.25 percent to 20 percent of the filling by weight,
a functional food having a daily intake reported by the United States Food and Drug Administration, wherein the filling contains 25 percent to 100 percent of prevailing daily intake recommendation by the United States Food and Drug Administration,
a functional food having a daily intake reported by the European Commission, wherein the filling contains 25 percent to 100 percent of prevailing daily intake recommendation by the European Commission,
a functional food having a daily intake reported by the FAO, wherein the filling contains 25 percent to 100 percent of prevailing daily intake recommendation by the FAO, and
a functional food having a daily intake reported by the Codex Alimentarius, wherein the filling contains 25 percent to 100 percent of prevailing daily intake recommendation by the Codex Alimentarius.
